(19) United States
(12) Patent Application Publication
(10) Pub. No.: US 2010/0322640 A1
(43) Pub. Date: Dec. 23, 2010

(54) IMAGE FORMING DEVICE, A FAILURE PREDICTION METHOD EXECUTED BY AN IMAGE FORMING DEVICE, AND A COMPUTER READABLE STORAGE MEDIUM STORING A PROGRAM FOR CONTROLLING AN IMAGE FORMING DEVICE

(75) Inventor: Kei Yamada, Atsugi-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Chiyoda-ku (JP)

(21) Appl. No.: 12/817,402

(22) Filed: Jun. 17, 2010

(30) Foreign Application Priority Data
Jun. 19, 2009 (JP) 2009-146816

(51) Int. Cl. G03G 15/00

(52) U.S. Cl. 399/11

(57) ABSTRACT

The image forming device according to the present invention can making accurate failure prediction without using a high-capacity storage device is provided. The image forming device has a detecting unit for detecting certain abnormality which portends a breakdown of the image forming device itself, an instructing unit for instructing user about an operation test on the region where the abnormality has been detected by the detecting unit (S201), a testing unit for performing the operation test on the region with assistance of the user who has been instructed by the instructing unit (S203), a measuring unit for measuring values describing the current status of the region during the operation test by the testing unit (S204), and a predicting unit for conducting the failure prediction on the region based on the valued measured by the measuring unit (S205).

### CROSS-REFERENCE TO RELATED APPLICATION

This application is based on Japanese Patent Application No. 2009-146816, filed on Jun. 19, 2009, the contents of which are incorporated herein by reference.

### BACKGROUND

1. Technical Field

The present invention relates to an image forming device that is capable of making failure prediction on its various regions, a failure prediction method executed by the image forming device, and a computer-readable recording medium storing a control program for the image forming device.

2. Description of Related Art

In recent years, MFP's improved performance enabled its shared use by many users, and thereby resulted in reduction of its introduction cost. However, such shared use of a MFP could possibly cause all the users a lot of trouble if the MFP stops operation due to a failure. Hence there is high demand for failure prediction technologies which allow for an accurate prediction of the time when failures is likely to occur in a MFP, so that it can be properly maintained or repaired before breaking down.

Previously, the most commonly-used method of MFP's failure prediction was to store a set of data measured by sensors installed in various regions within a MFP into a high-capacity storage device like a hard disk, and statistically analyze chronological change in the measured data. For example, the Japanese Unexamined Publication No. 2007-256356 discloses a failure prediction method which includes calculating an abnormality index value for the most-recently acquired data set from normal data sets stored in a hard disk, which have been obtained at certain intervals.

However, the conventional technology described above has a defect in its high introduction cost due to the necessity for a high-capacity hard disk. Moreover, this technology only involves periodical acquisition of normal data, and hence it does not make use of abnormal data corresponding to MFP's malfunctions like a paper jam which portend a MFP failure although analysis of such abnormal data are known to be effective in accurate failure prediction.

The present invention is intended to solve the above-mentioned problems in the prior art, and its object is to provide an image forming device capable of highly-accurate failure prediction without the necessity for a high-capacity storage device.

### SUMMARY

To achieve at least one of the above-mentioned objects, an image forming device reflecting an aspect of the present invention comprises a detecting unit, an instructing unit, a testing unit, a measuring unit, predicting unit.

The detecting unit detects certain abnormality which portends a breakdown of the image forming device. The instructing unit instructs user about an operation test on the region where the abnormality has been detected by the detecting unit. The testing unit performs the operation test on the region with assistance of the user who has been instructed by the instructing unit. The measuring unit measures values which describe the current status of the region during the operation test by the testing unit. Finally, the predicting unit makes failure prediction on the region based on the values measured by the measuring unit.

Preferably, the image forming device further comprises a first communication unit for downloading a failure prediction program from an external server, and the predicting unit makes the failure prediction using the program downloaded by the first communication unit.

Preferably, the first communication unit selectively downloads the failure prediction program according to the type of the abnormality detected by the detecting unit.

Preferably, the image forming device further comprises a display unit for displaying the result of the failure prediction by the predicting unit. Preferably, the display unit forms apart of an operation panel of the image forming device.

Preferably, the image forming device further comprises a function restriction determining unit for determining function restriction to be imposed on the image forming device, from the result of the failure prediction by the predicting unit, and the operation panel displays information on the function restriction determined by the function restriction determining unit.

Preferably, the operation panel displays a warning message for advising user not to use the function affected by the function restriction determined by the function restriction determining unit if it is selected by user.

Preferably, the image forming device further comprises a second communication unit for sending information on the function restriction determined by the function restriction determining unit, to a printer driver for configuring print settings of the image forming device, so that the printer driver can display information on the function restriction on its print setting screen.

Preferably, the predicting unit makes the failure prediction based on the values measured at the time when the abnormality has been detected by the detecting unit.

Preferably, the image forming device further comprises a third communication unit for sending information on the result of the failure prediction by the predicting unit, to an external control system.

The objects, features, and characteristics of this invention other than those set forth above will become apparent from the description given below with reference to preferred embodiments illustrated in the accompanying drawings.

### BRIEF DESCRIPTION OF THE DRAWINGS

FIG. 1 is a block diagram showing an exemplary structure of the failure prediction system including the image forming device according to one embodiment of the present invention.

FIG. 2 is a block diagram showing an exemplary structure of the PC shown in FIG. 1.

FIG. 3 is a block diagram showing an exemplary structure of the MFP shown in FIG. 1.

FIG. 4 is a flowchart showing exemplary steps of the failure prediction according to one first embodiment of the present invention.

FIG. 5 is a flowchart showing exemplary steps of the script execution according to one embodiment of the present invention.

FIG. 6 is a flowchart showing exemplary steps for the function restriction for the copying function according to one embodiment of the present invention.

FIG. 7 is a flowchart showing exemplary steps for the function restriction for the print function according to one embodiment of the present invention.

FIG. 8 is a schematic view of the copying setting UI screen according to an embodiment of the present invention.

FIG. 9 is a schematic view of the copying setting UI screen according to one embodiment of the present invention.

FIG. 10 is a schematic view of the print setting UI screen according to one embodiment of the present invention.

FIG. 11 is a schematic view for illustrating the advantageous effects according to one embodiment of the present invention.

### DETAILED DESCRIPTION

The embodiment of this invention is described below with reference to the accompanying drawings.

### <System Structure>

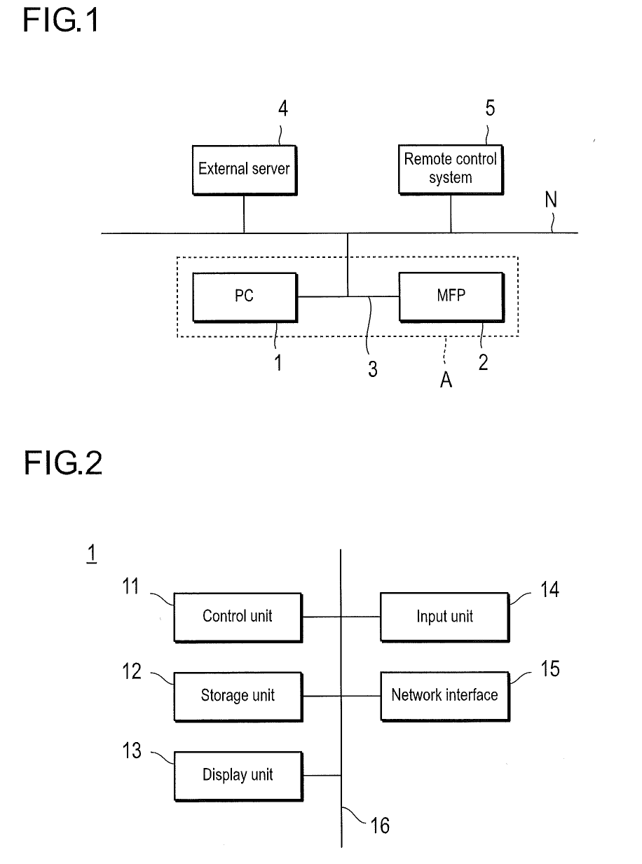

FIG. 1 is a block diagram showing an exemplary structure of a failure prediction system in which an MFP 2 serves as an image forming device according to the embodiment of the present invention. As shown in FIG. 1, the failure prediction system according to the embodiment includes an image forming system A, an external server 4, and a remote control system 5, all of which are connected one another via a network N so that they are capable of interactive communications. The network N can be a public communication network such as ISDN or CATV, a computer network such as LAN, WAN and Internet, or a dedicated circuit to be used exclusively by users of the system.

As shown in FIG. 1, the image forming system A includes a PC 1 which serves as a client device, and the MFP 2 which serves as an image forming device having functions to print the data received from the PC 1 and to copy various documents, and they are connected with each other by a LAN 3 for their interactive communications. The image forming system A is connected to the network N via the LAN 3. The LAN 3 includes a router, a proxy server, and other communication devices for relaying data exchange between the image forming system A and various other devices on the network N although they are not shown in the figures.

An exemplary structure of each device is described in detail below while each device may also include any other constituents than those described below, or only include part of the constituents described below. Descriptions of any functions common to more than one device will be made only once, and will not be repeated to avoid redundancy.

FIG. 2 is a block diagram showing en exemplary structure of the PC 1. As shown in FIG. 2, the PC 1 includes a control unit 11, a storage unit 12, a display unit 13, an input unit 14, and a communication interface 15, all of which are interconnected via a bus 16 for exchanging signals. These elements will be described in detail below.

The control unit 11 is a CPU for not only performing various calculations, but also controlling each of the elements according to various control programs. The storage unit 12 includes a ROM for storing control programs and parameters for controlling PC 1's basic operations, a RAM for temporarily storing control programs to serve as a working area, and a hard disk for storing an OS (operating system or basic software) as well as control programs and parameters for controlling PC 1's specific operations to be described later. The hard disk of the storage unit 12 particularly stores various applications for producing document files, and a printer driver for configuring MFP 2's print function.

The display unit 13 is a display device such as a CRT display and a liquid crystal display, and displays various kinds of information to the user who tries to operates the PC 1. The display unit 13 particularly displays an UI (User Interface) screen for print settings, which is offered by the aforementioned printer driver. FIG. 9 is an schematic view of the print setting UI screen “u”.

The input unit 14 includes a keyboard and a mouse for acquiring various instructions from user. The communication interface 15 is an interface for communicating with the MFP 2 via the LAN 3, and is typically a network interface to a standard such as Ethernet®, TokenRing, and FDDI, a serial interface such as USB and IEEE 1394, a parallel interface such as SCSI and IEEE 1284, etc.

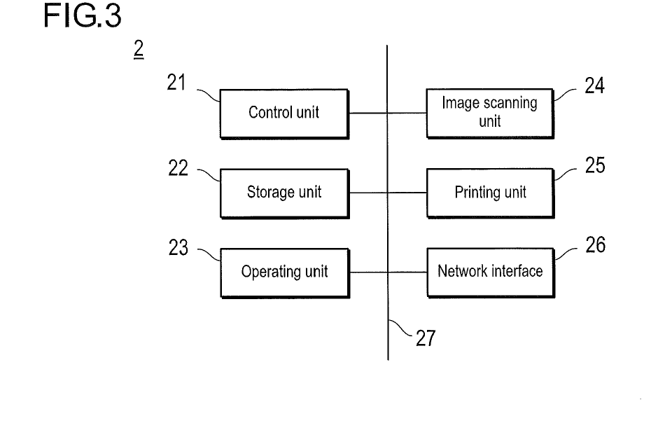

FIG. 3 is a block diagram showing an exemplary structure of the MFP 2. As shown in FIG. 3, the MFP 2 includes a control unit 21, a storage unit 22, an operating unit 23, an image scanning unit 24, a printing unit 25, and a communication interface 26, all of which are interconnected via a bus 27 for exchanging signals. These elements are be described in details below.

The control unit 21 is a CPU for not only performing various calculations, but also controlling each of the elements according to various control programs. The storage unit 22 includes a ROM for storing control programs and parameters, a RAM for temporarily storing control programs to serve as a working area, and a hard disk for storing an OS (operating system or basic software) as well as control programs and parameters for controlling MFP 2's specific operations as described later.

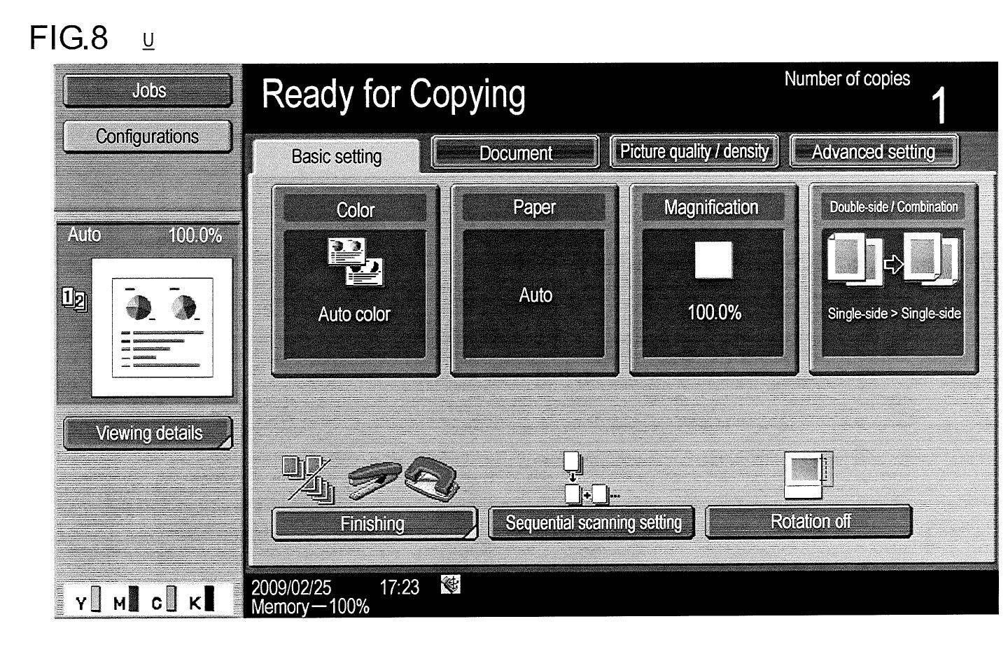

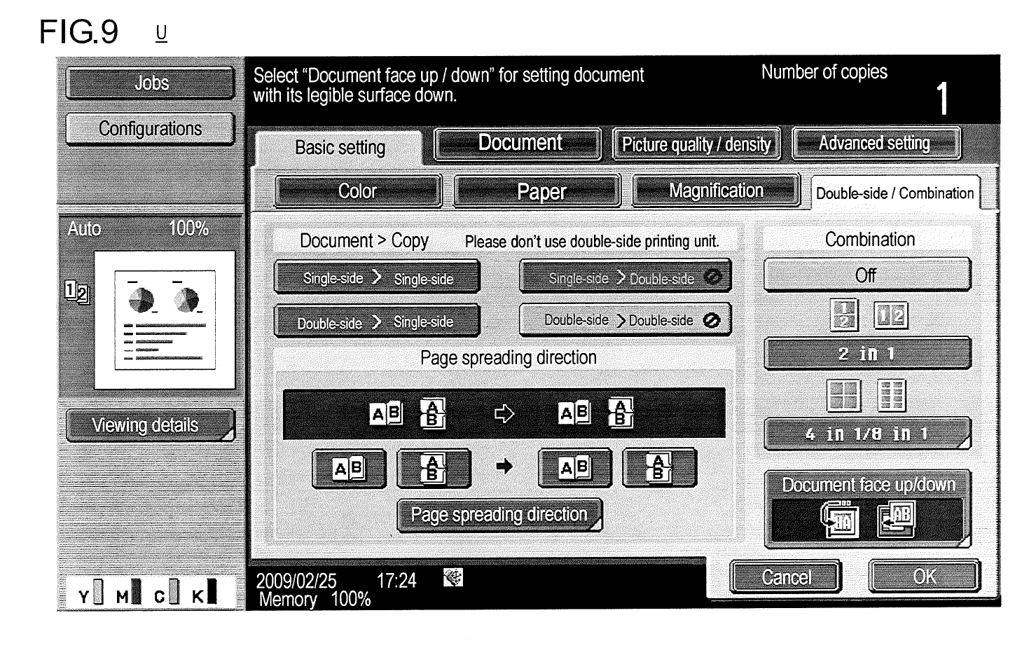

The operating unit 23 includes a touch panel which is capable of not only displaying MFP 2's status and various kinds of setting information, but also receiving various instructions from user. The operating unit 23 may further includes various fixed keys such as ten-keys for receiving the number of copies, Start & Stop keys for receiving instructions to start and stop operations, and a Reset key for receiving an instruction to initialize the settings as well various display lamps. In particular, the touch panel of the operating unit 23 displays a copying setting UI screen U for configuring MFP 2's copying function. FIG. 8 and FIG. 9 each shows schematic view of the copying setting UI screen “u”.

What is shown in FIG. 8 is an initial status of the setting screen which appears on MFP 2's start-up, and this initial screen is replaced by an advanced setting screen shown in FIG. 9 when the “Double-side/Combination” icon in FIG. 8 is clicked.

The image scanning unit 24 performs the scanning which comprises irradiating by a light source like a fluorescent lamp, a document placed on a certain location on a document table or transported to the location by an ADF (Auto Document Feeder) with a light source like a fluorescent lamp, converting the scanned image into electrical signals by means of a light sensing element like a CCD image sensor and a CMOS image sensor to generate image data (bitmap data) for printing.

The ADF is provided with a plurality of optical sensors along its paper path, and these sensors measure the time of document passage through their locations. The feed roller for transporting documents is provided with rotary encoders. The data measured by the sensors and encoders is used for the failure detection of the MFP 2 as described later.

The print unit 25 prints on printing paper an image based on the image data generated by the image scanning unit 24 or received from the PC 1 using the electro-photographic technology. More specifically, the printing unit 25 forms an image on the printing paper by a method having a charging step for electrically charging a sensitizer drum, an exposing step for exposing a static latent image on the sensitizer drum by means of laser beam, a developing step for forming a toner image by applying toner to the electrostatic latent image on the sensitizer drum, a transferring step for transferring the toner image on the sensitizer drum to the printing paper by means of a transfer belt, and a fixing step for heating the toner image on the printing paper to fix it thereto.

The printing unit 25 is provided with a plurality of optical sensors along its paper path, and these sensors measure the time of paper passage through their locations. Each of the rotary members like the sensitizer drum, the transfer belt drive roller, and the fixing roller is provided with rotary encoders. The data measured by these sensors and the rotary encoders is also used for the failure detection of the MFP 2 as described later.

The communication interface 26 is an interface for communicating with the PC 1 via the LAN 3, and is typically a network interface to a standard such as Ethernet®, TokenRing, and FDDI, a serial interface such as USB and IEEE 1394, a parallel interface such as SCSI and IEEE 1284, etc.

Referring to FIG. 1 again, the external server 4 is a file server capable of storing and transferring various files. The external server 4 stores a set of programs for making failure prediction on various regions of the MFP 2 based on the data measured by the aforementioned sensors and encoders, and it transfers these programs to the MFP 2 in response to a request from it. These programs are hereinafter referred to as “scripts” as they are normally written in script languages. Each of the scripts stored in the external server 4 is suitable to failure prediction on a certain region of the MFP 2, and the MFP 2 can download the optimum script according to its current status. Moreover, the scripts in the external server 4 can be continually updated based on their performance records which are available on the market, so that the MFP 2 can download the latest version of the script for obtaining the most accurate failure prediction result.

Referring to FIG. 1 again, the remote control system 5 of the present embodiment is a computer system capable of monitoring the operating status of the MFP 2 from a remote location via the network N, and executing maintenance control of the MFP 2. The remote control system 4 is also capable of issuing an order to dispatch a serviceman to MFP 2's location upon receiving a notice which is sent by the MFP 2 when the failure prediction results in a high chance of failure occurrence. This allows the dispatched serviceman to repair or maintain the MFP 2 before actual failure occurrence.

### <Flowchart>

Details of the failure prediction by the MFP 2 according to the present embodiment are given below with reference to the flowchart. The following example shows the failure prediction on MFP 2's machine components which are involved in the transportation of copy/printing paper within the MFP 2 (hereinafter referred to generically as “transport unit”).

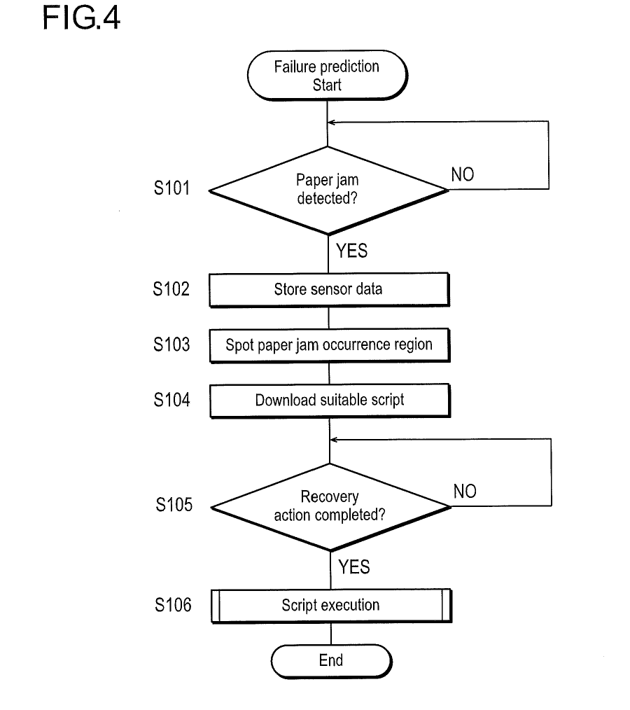

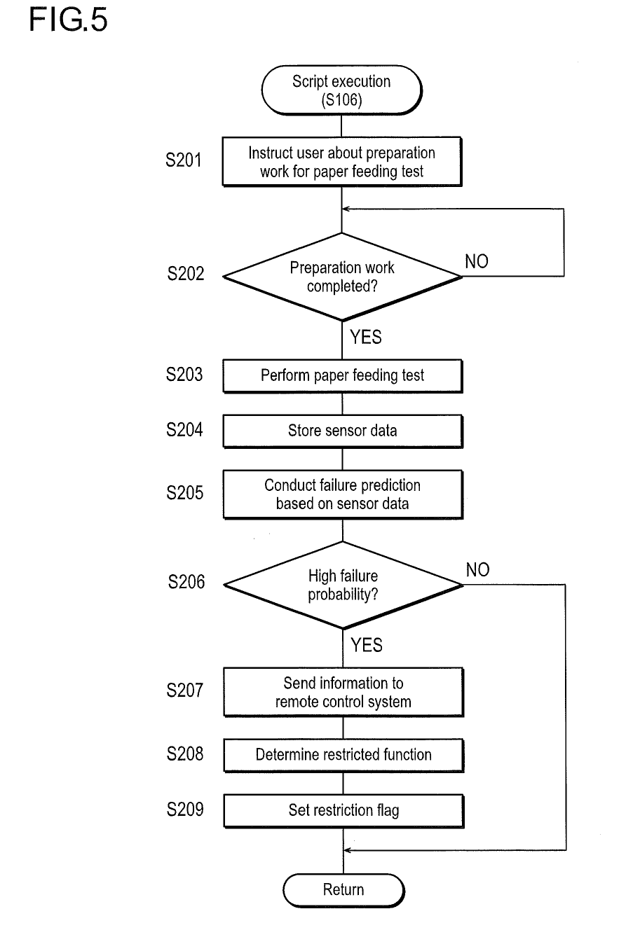

FIG. 4 is a flowchart showing exemplary steps of MFP 2's failure prediction according to the embodiment. The algorithm shown in the flowchart of FIG. 4 is stored in the ROM as a control program, and is read out to be executed by the CPU when the program starts.

Firstly, the MFP 2 waits to detect any abnormality that portends a failure of the MFP 2 (S101: No). More specifically, the MFP 2 of the present embodiment waits to detect paper jam as it portends a failure in the transport unit. The paper jam detection method employed by the MFP 2 of the present embodiment includes, but not limited to, a method with a step of detecting any copy/printing paper that is retained in the paper path for a certain period of time, using the aforementioned sensors.

Once paper jam is detected (s101: Yes), the MFP 2 stores data on the time of the latest paper passage measured by each sensor into the storage unit 22 (S102). The data stored in this step is hereinafter referred to as “first sensor data”. The MFP 2 then analyzes the first sensor data to spot the region where the paper jam occurred (S103). More specifically, the MFP 2 localizes the sensor which detected abnormal passage time at the time when the paper jam was detected, and recognizes the vicinity of the sensor as the paper jam occurrence region.

This is how the MFP 2 spot the paper jam occurrence region, but it is still unclear whether the paper jam occurrence should be ascribed to an accidental event like erroneous paper feeding, or to a permanent event like wear-out or malfunction of the machine components. Therefore, the MFP 2 conducts more advanced failure prediction using a downloaded script which accompanies an operation test on the paper jam occurrence region as detailed below.

Next, the MFP 2 communicates with the external server 4 via the network N to download the failure prediction script for the paper jam occurrence region spotted in step S103 (S104). For example, the MFP 2 downloads a failure prediction script for the ADF if the paper jam occurrence region spotted in step S103 turns out to be the ADF. As such, the MFP 2 downloads the most suitable script to the current status of the faulty region among those stored in the external server 4.

Next, the MFP 2 waits for completion of user's recovery action on the paper jam (S105: No). As soon as the user completes the recovery action (S105: Yes), the MFP 2 executes the downloaded script in step S104 (S106) for the paper jam occurrence region, to finish the series of steps (End). Details of the script execution in step S106 are described below. The method employed by the MFP 2 of the present embodiment for determining whether user's recovery action has been completed includes but not limited to a method with a step of receiving user's key operation to indicate the completion through the operating unit 23.

Next, details of the script execution in step S106 are described below with reference to FIG. 5. Firstly, the MFP 2 prompts user to carry out preparation work for the operation test on the abnormality occurrence region (S201), which is also a subject of the subsequent failure prediction. More specifically, the MFP 2 in this example prompts user to carry out preparation work for the paper feeding test on the paper jam occurrence region. The paper feeding test herein means a test involving forced paper feeding through the paper jam occurrence region (e.g., ADF), and the preparation work for this test herein means user's manual work to set printing paper on the paper feed tray of the ADF. The aforementioned preparation work won't cause the user much trouble as the user is supposed to stay close to the MFP 2 after the recovery action on the paper jam.

Next, the MFP 2 waits for completion of user's preparation work in response to the instruction in step S201 (S202: No), and then starts the paper feeding test on the paper jam occurrence region (S203) upon completion of the preparation work (s202: Yes). The MFP 2 then measures the time of paper passage by each sensor, and stores the data into the storage units (S204). The data stored in this step is hereinafter referred to as “second sensor data”, in comparison to the “first sensor data” mentioned above.

The MFP 2 conducts the failure prediction on the paper jam occurrence region based on the first and second sensor data (S205). The failure prediction method employed by the MFP 2 in this example includes but not limited to a method having steps of calculating an abnormal index value for the first and second sensor data by multivariable analysis, and evaluate a failure probability of the paper jam occurrence region based on the calculation result. The abnormality index can typically be the Maharanobis' generalized distance between the first/second sensor data and a pre-established normal data group. There has to be a predetermined correlation between calculation of abnormality index values like the Maharanobis' distance and failure probability values of individual paper jam occurrence regions.

As can be seen from the above, more accurate failure prediction result can be achieved by utilizing the sensor data obtained during the operation test (e.g., paper feeding test) which immediately follows the abnormality (paper jam) occurrence. the prediction accuracy can also be improved by using the measured data by the rotary encoders attached to various rotating members including the ADF feed roller, the sensitizer drum, the transfer belt drive roller, and the fixing roller although the MFP 2 in this example only uses data measure by the optical sensors installed along the paper path for copy/printing paper.

Next, the MFP 2 splits the rest of the steps according to the failure prediction result in step S205 (S206). More specifically, the MFP 2 finishes (End) the series of steps if the failure probability evaluated in step S205 turns out to be below a certain level (S206: No). On the other hand, the MFP 2 proceeds to step S207 if the failure probability evaluated in step S205 turns out to be equal to or above a certain level (S206: Yes).

In step S207, the MFP 2 notifies the remote control system 5 of the failure prediction result in step S205 via the network N. Upon receiving that notice, the remote control system 5 transmits a service instruction to a terminal device carried by a serviceman by email. Upon receiving that service instruction, the serviceman will move rapidly to the location of the MFP 2 to perform repair or maintenance on the paper jam occurrence region.

In the meantime, certain function restriction should be imposed on the MFP 2 until serviceman's arrival. This is to ensure that the paper jam occurrence region will not be operated until it is fixed by the serviceman. Therefore, the MFP 2 determines the function of the MFP 2 which involves operation of the paper jam occurrence region (S208). The function subject to the function restriction is hereinafter called “restricted function”. For example, the MFP 2 determines “double-side printing”, which involves operation of the ADF, as restricted function, if the paper jam occurrence region is the ADF.

Finally, the MFP 2 sets a function restriction flag for the restricted function determined in step S208, in the storage area 22 (S209), before finishing the series of steps (Return). The MFP 2 preferably gets rebooted upon completion of the script execution, but the flag set in step S209 remains held in the storage unit 22 after the reboot as it is a nonvolatile flag. After the reboot, the MFP 2 refers to the flag to establish the relevant function restriction on itself. The steps of the function restriction are described in detail below.

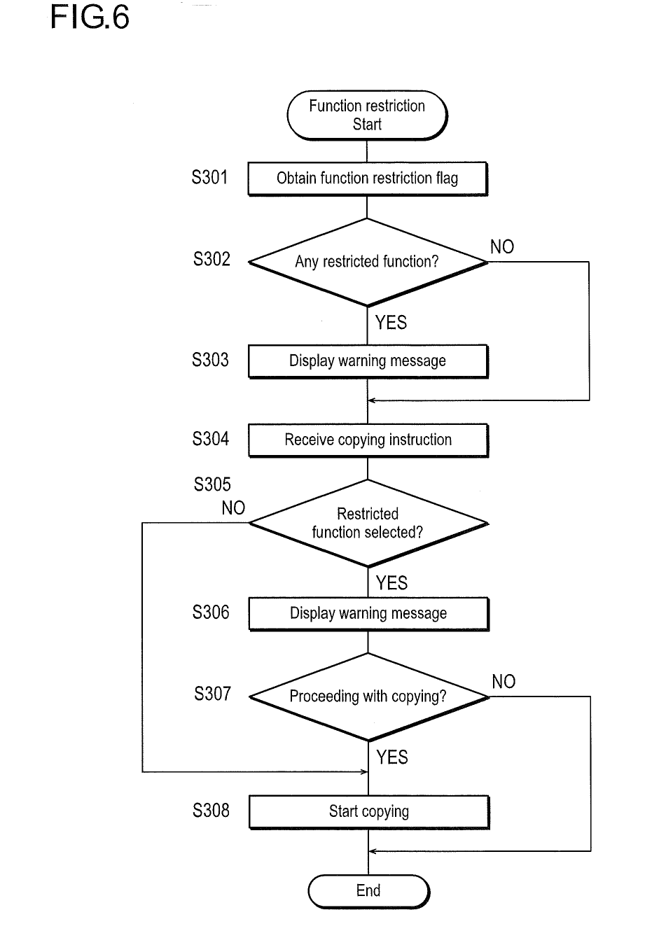

FIG. 6 is a flowchart showing exemplary steps of the function restriction executed by the MFP 2 upon the reboot after the script execution. The MFP 2 firstly reads out the flag set in step S209 from the storage unit 22 (S301) in order to judge whether or not there is any restricted function (3302). The MFP 2 moves to step S304 if there is no restricted function (S302: No). On the other hand, if there is any restricted function (S302: Yes), the MFP 2 displays a warning message advising user not to use the restricted function (S303). For example, the MFP 2 displays the warning message: “Please don't use the double-side printing unit.” on the copying setting UI screen U in the operating unit 23 if the restricted function turns out to double-side printing (refer to FIG. 8).

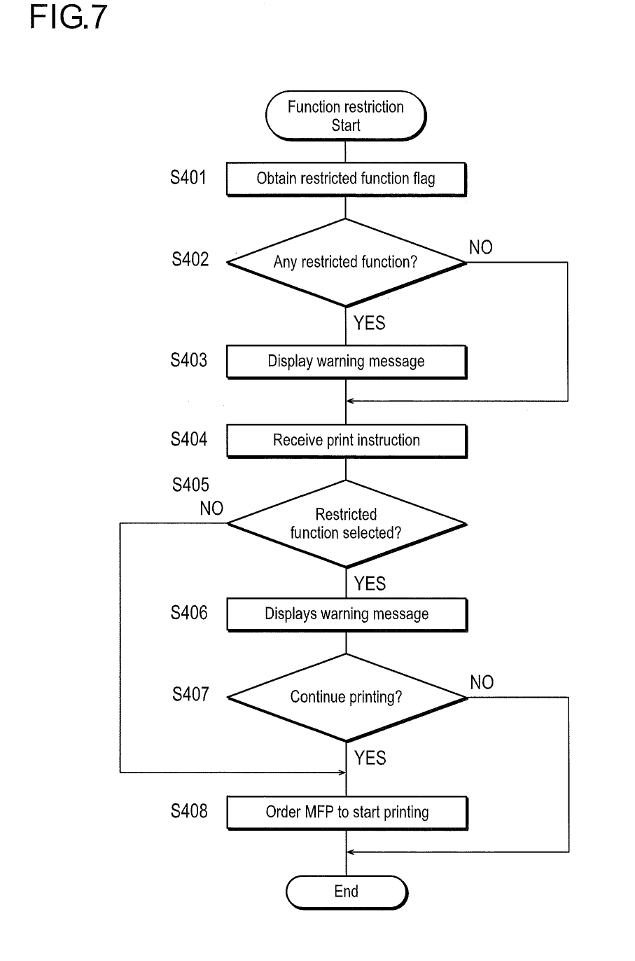

Upon receiving user's instruction to start the copying (S304), the MFP 2 judges whether or not the copying settings configured on the UI screen U includes selection of any restricted function (S305), and splits the rest of the steps according to the judgment result. More specifically, the MFP 2 asks for user's final confirmation as to whether or not it should proceed with the copying by displaying another warning message to allow him/her to have a second thought (S306) if the copying settings include any restricted function (S305: Yes). On the other hand, the MFP 2 immediately starts the copying (S308) if the copying settings do not include any restricted function (S305: No). For example, the MFP 2 switches the UI screen U to the one as shown in FIG. 8, and displays the further warning message: “Please don't use the double-side printing unit” if the user has defied the warning as shown in FIG. 7 and selected the icon: “Double-side/Combination”.

The MFP 2 then starts the copying (S308) to finish the series of steps (End) if it receives an instruction to proceed with the copying (S307: Yes) i.e. if either the button: “Single-side=>Double-side” or the button: “Double-side=>Double-side” has been selected on the UI screen shown in FIG. 8. On the other hand, the MFP 2 finishes the series of steps (End) without proceeding with the copying if it receives an instruction not to proceed with the copying (S307: No) i.e. if the button: “Cancel” is selected on the UI screen shown in FIG. 8.

Such function restriction as described above ensures that unfavorable use of the abnormality occurrence region like paper jam can be avoided, and thereby minimizing downtime of the MFP 2 as a whole. The function restriction according to the present embodiment is applicable not only to MFP 2's copying function as described in FIG. 6, but also to its print function which can be utilized via the PC 1. The function restriction for MFP 2's print function is described in details below.

FIG. 7 is a flowchart showing exemplary steps of the function restriction executed by PC 1's printer driver upon completion of the script execution as shown in FIG. 5. The algorithm shown in this flowchart is stored in the ROM as a control program, and is read out to be executed by the CPU when the program starts.

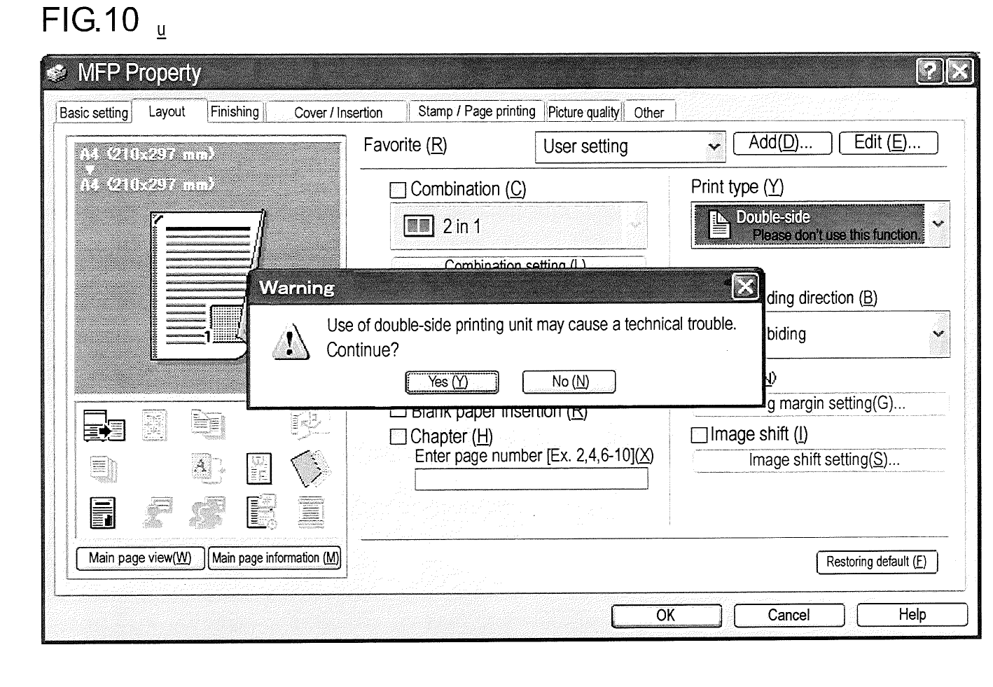

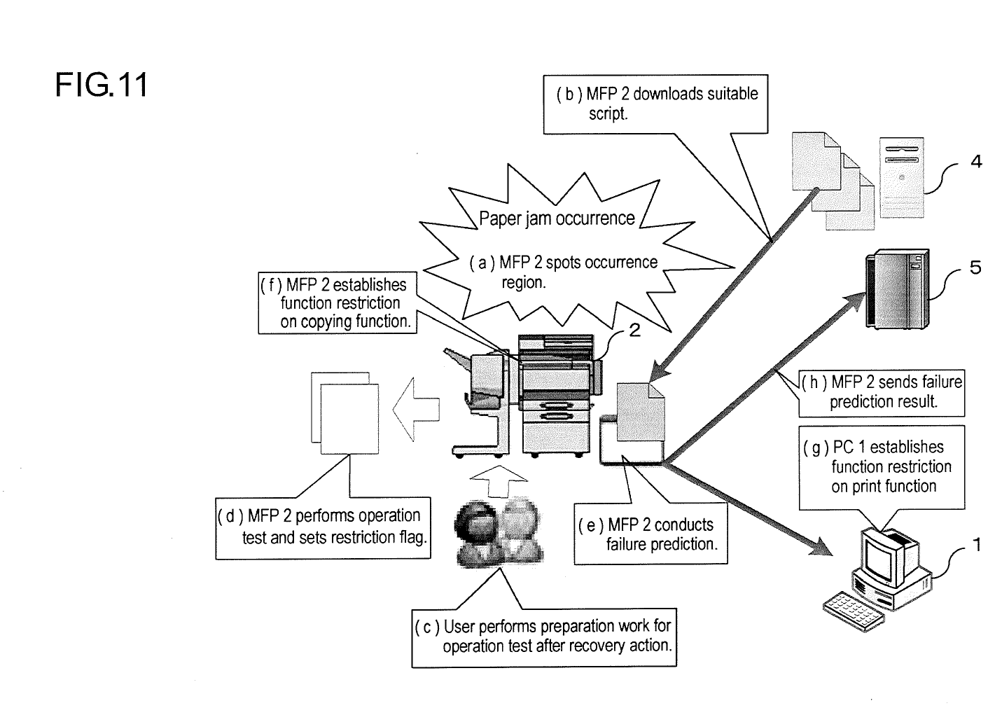

The PC 1 firstly communicates with the MFP 2 via the network N in order to obtain the flag retained in the storage unit 22 (S401). The PC 1 then judges whether or not there is any restricted function based on the flag obtained in step S401 (S402), and moves directly to step S404 if there is no restricted function (S402: No). On the other hand, if there is any restricted function (S402: Yes), the PC 1 displays a warning message advising user not to use the restricted function (S403). For example, the PC 1 displays the warning message: “Please don't use this function.” on the print setting UI screen u on the display unit 13 (refer to FIG. 10).

Upon receiving user's instruction to start printing (S404), the PC 1 judges whether or not the print settings configured on the UI screen u includes selection of any restricted function (S405), and splits the rest of the steps according to the judgment result. More specifically, the MFP 2 asks for user's final confirmation as to whether or not it should proceed with the printing by displaying another warning message to allow him/her to have a second thought (S406) if the print settings include any restricted function (S405: Yes). On the other hand, the PC 1 immediately orders the MFP 2 to start the printing (S408) if the print settings do not include the restricted function. For example, the PC 1 displays a pop-up with the warning message: “Use of double-side printing unit may cause a technical trouble. Continue?” as shown in FIG. 10.

The PC 1 then orders the MFP 2 to start the printing (S408) before finishing the series of steps (End) if receives an instruction to continue the printing (S407: Yes) i.e. if the button: “Yes” is selected on the pop-up in FIG. 10. On the other hand, the PC 1 finishes the series of steps (End) without ordering the MFP 2 to start the printing if it receives an instruction not to continue the printing (S407: No) i.e. if the button: “No” is selected on the pop-up in FIG. 10.

The advantageous effects of the present embodiment are described below in detail. The failure prediction system with the MFP 2 of the present embodiment as a whole serves to conduct the failure prediction on the MFP 2 in the followings steps (a) to (f):

(a) When paper jam is detected, the MFP 2 localizes the abnormality occurrence region (e.g., ADF) based on the sensor data.

(b) The MFP 2 downloads from the external server 4 the most suitable script to the localized paper jam occurrence region.

(c) User performs the preparation work for the operation test on the paper jam occurrence region according to the instruction on the UI screen U, after finishing the recovery action on the region. For example, user sets printing paper in a paper feeding tray of the ADF if the paper jam occurrence region turns out to be the ADF.

(d) The MFP 2 causes its sensors to measure data on the paper passage time during its operation test on the paper jam occurrence region.

(e) The MFP 2 conducts the failure prediction on the paper jam occurrence region based on the sensor data measured during the operation test, and sets the function restriction flag in the storage unit 22 corresponding to the failure prediction result.

(f) The MFP 2 establishes the function restriction on its copying function based on the flag in the storage unit 22. More specifically, the MFP 2 displays a warning message advising user not to use the restricted function (e.g., double-side printing) on the copying setting UI screen “U”.

(g) The PC 1 establishes the function restriction on the printing function based on the flag obtained from the MFP 2. More specifically, the PC 1 displays a warning message advising user not to use the restricted function (e.g., double-side printing) on the print setting UI screen “u”.

(h) The MFP 2 sends the failure prediction result to the remote control system 5. Upon receiving the report, the remote control system 5 arranges for a serviceman dispatch.

As can be seen from the steps (a) and (b), the MFP 2 according to the present embodiment selectively downloads the most suitable failure prediction script to the abnormality occurrence region such as paper jam occurrence region. As such, this embodiment allows for reduced network load on the network N during the script downloading as well as reduced processing load on the MFP 2 during the failure prediction. Furthermore, the present embodiment can achieve to more accurate prediction result by continually updating the scripts on the external server 4 based on their performance records available on the market.

As can be seen from (c) and (d) above, the MFP 2 according to the present embodiment conducts the failure predictions based on the sensor data measured during the operation test on the abnormality occurrence region. Thus, this embodiment eliminates the need to accumulate normal operation data in advance, and thereby achieving accurate failure prediction result without a high-capacity storage unit. Furthermore, the present embodiment doesn't put user to much trouble with the preparation work for the operation test as all he/she should do is to proceed to the preparatory work after finishing the recovery action on the on the paper jam occurrence region by following the instruction on the copying setting UI screen U.

As can be seen from the steps (e) to (h) above, the MFP 2 and the PC 1 (printer driver) according to the present embodiment configure proper function restriction on MFP 2's copying and print functions based on the failure prediction result. Therefore, the present embodiment can effectively prevent a breakdown of the entire MFP 2, which can be caused by excessive use of the abnormality occurrence region (e.g., ADF) before arrival of a serviceman. In other words, the present embodiment can minimize MFP 2's possible downtime, and thereby enhancing its user-friendliness.

The invention is not limited to the embodiment described above, and hence it can be modified within the scope of the appended claims. For example, the system of the present embodiment starts executing the failure prediction script when its sensors detect certain abnormality (e.g., paper jam) in the transport unit, but the present invention is not limited to this. For example, the system of the present invention can also cause its various units including the transfer and fixing units to record the accumulated number of counts representing their operational status, and regards excessive counts beyond a certain threshold level as abnormality occurrence which should trigger the script execution.

The image forming device according to this invention can be implemented as a dedicated hardware circuit for executing each of the above-mentioned steps, or a program executed by a CPU to perform the aforementioned steps. If the present invention is implemented as the latter, the programs for driving the image forming device can be offered in the form of a computer-readable recording media such as a floppy® disk and a CD-ROM, or a downloadable file via a network like the Internet. The program recorded in a computer readable recording medium is normally transferred to a ROM, hard disk or other memory devices. The program can also be offered in the form of an independent application software, or can be built into a software of the image processing device to serve one of its functions.

What is claimed is:

1. An image forming device comprising:
a detecting unit for detecting certain abnormality which portends a breakdown of said image forming device;
an instructing unit for instructing user about an operation test on the region where said abnormality has been detected by said detecting unit;
a testing unit for performing the operation test on said region with assistance of the user who has been instructed by said instructing unit;
a measuring unit for measuring values which describe the current status of said region during said operation test by said testing unit; and
a predicting unit for making failure prediction on said region based on said values measured by said measuring unit.

2. The image forming device as claimed in claim 1 further comprising a first communication unit for downloading a failure prediction program from an external server, wherein said predicting unit makes said failure prediction using said failure prediction program downloaded by said first communication unit.

3. The image forming device as claimed in claim 2, wherein said first communication unit selectively downloads said failure prediction program according to the type of said abnormality detected by said detecting unit.

4. The image forming device as claimed in claim 1 further comprising a display unit for displaying the result of said failure prediction by said predicting unit.

5. The image forming device as claimed in claim 4, wherein said display unit forms a part of an operation panel of said image forming device.

6. The image forming device as claimed in claim 5 further comprising a function restriction determining unit for determining function restriction to be imposed on said image forming device, from the result of said failure prediction by said predicting unit, wherein said operation panel displays information on said function restriction determined by said function restriction determining unit.

7. The image forming device as claimed in claim 6, wherein said operation panel displays a warning message for advising user not to use the function affected by said functional restriction determined by said function restriction determining unit if it is selected by user.

8. The image forming device as claimed in claim 6 further comprising a second communication unit for sending information on said function restriction determined by said function restriction determining unit, to a printer driver for configuring print settings of said image forming device, so that said printer driver can display information on said function restriction on its print setting screen.

9. The image forming device as claimed in claim 1 wherein, said predicting unit makes said failure prediction based on said values measured at the time when said abnormality has been detected by said detecting unit.

10. The image forming device as claimed in claim 1 further comprising a third communication unit for sending information on the result of said failure prediction by said predicting unit, to an external control system.

11. A failure prediction method to be executed by an image forming device comprising the steps of:
(A) detecting certain abnormality which portends a breakdown of said image forming device;
(B) instructing user about an operation test on the region device where said abnormality has been detected in step (A);
(C) performing the operation test on said region with assistance of user who has been instructed in step (B);
(D) measuring values describing the current status of said region during said operation test in step (C); and
(E) making failure prediction for said region based on said values measured in said step (D).

12. The failure prediction method as claimed in claim 11 further comprising the step of (a) downloading a failure prediction program from an external server, wherein in said step (D) said failure prediction is made using said failure prediction program downloaded in said step (a).

13. The failure prediction method as claimed in claim 12, wherein, in said step (a), said failure prediction program is selectively downloaded according to the type of said abnormality detected in said step (A).

14. The failure prediction method as claimed in claim 11 further comprising the steps of (b) displaying on a display unit, the result of said failure prediction made in said step (E).

15. The failure prediction method as claimed in claim 14, wherein said display unit forms a part of an operation panel of said image forming device.

16. The failure prediction method as claimed in claim 15 further comprising the steps of:
(c) determining function restriction to be imposed on said image forming device, from the result of said failure prediction in said step (E); and
(d) displaying on said operation panel, information on said function restriction determined in said step (c).

17. The failure prediction method as claimed in claim 16 further comprising the step of displaying on said operation panel, a warning message for advising user not to use the function affected by said function restriction determined in said step (c) if it is selected by user.

18. The failure prediction method as claimed in claim 16 further comprising the step of sending information on said function restriction determined in said step (c) to a printer driver for configuring print settings of said image forming device, so that said printer driver can display information on said functional restriction on its print setting screen.

19. The failure prediction method as claimed in claim 11, wherein, in said step (E), said failure prediction is made based on said values measured at the time when said abnormality has been detected in said step (A).

20. The failure prediction method as claimed in claim 11 further comprising the step of sending information on the result of said failure prediction in said step (E), to an external control system.

21. A computer readable recording medium storing a program causing an image forming device to execute the steps of:
(A) detecting certain abnormality which portends a breakdown of said image forming device;
(B) instructing user about an operation test on the region where said abnormality has been detected in step (A);
(C) performing the operation test on said region with assistance of user who has been instructed in said step (B);
(D) measuring values describing the current status of said region during said operation test in said step (C); and
(E) making failure prediction for said region based on said values measured in said step (D).
